(19) United States
(12) Patent Application Publication
(10) Pub. No.: US 2003/0101636 A1
(43) Pub. Date: Jun. 5, 2003

(54) Self-sealing decoy

(76) Inventor: Joel James Pippert, Houston, TX (US)

Correspondence Address: JOEL J. PIPPERT, 10810 OLD KATY ROAD, SUITE 100, HOUSTON, TX, 77043, US

(21) Appl. No.: 10/273,461

(22) Filed: Oct. 18, 2002

Related U.S. Application Data
(60) Provisional application No. 60/336,676, filed on Dec. 5, 2001.

(51) Int. Cl. A01M 31/06

(52) U.S. Cl. 43/3

(57) ABSTRACT

A decoy having an outer skin and a compressed self-sealing flexible closed cell foam core.

When errant lead shot penetrates through the decoy, the pressurized foam displaces the hole left by the lead shot and prevents sinking of the decoy.

Version 1 has a blow molded skin filled with compressed closed cell foam core.

Version 2 is manufactured by coating a flexible closed cell foam core with typically a rubber or plastic coating and compressing and curing the coating in a mold thereby leaving the core in a compressed state.

Version 3 has two vacuum formed shells welded from two halves filled with pressurized flexible closed cell foam.

This is a “Non-Provisional” Patent Application which claims the benefit of U.S. Provisional Application No. 60/336,676, filed Dec. 5, 2001.

### ABSTRACT

A decoy having an outer skin and a compressed self-sealing flexible closed cell foam core.

Version 1 has a blow molded skin of typically polypropylene composition and is filled with pressurized flexible closed cell foam. When errant lead shot penetrates through the decoy the pressurized foam displaces the hole left by the shot and prevents sinking of the decoy.

Version 2 is manufactured by casting a flexible closed cell decoy shape then dipping, spraying or otherwise coating the core with typically a plastic or rubber coating. The coating may be fiber, powder or otherwise reinforced. The composite decoy is then compressed, molded and cured to a detailed finished shape. When errant lead shot penetrates through the decoy the pressurized foam displaces the hole left by the shot and prevents sinking of the decoy.

Version 3 has a shell, manufactured by conventional method of vacuum forming two halves and welding the halves together but is pressure filled with flexible closed cell foam.

All versions can be made with a flexible closed cell foam expanded at low temperature or above ambient pressure, or both, then cured. When ambient temperature and pressure are returned the foam is then in a compressed state, being contained by the skin or shell, to provide the self-sealing properties of the pressurized foam. The closed cell foam is necessary to prevent water from entering the structure. The pressure produced during the process provides compressed gas in the cells of the structure and compression and deformation of the cell walls to provide for expansion of the structure into holes caused by shot damage to displace water from the decoy.

The shell can also be over filled with flexible closed cell foam precast pellets or shapes. The shell can also be filled with foam or additives that expand on contact with water.

### BACKGROUND OF THE INVENTION

Waterfowl decoys are required to float on water and to provide a natural appearance. If they are damaged, particularly by errant lead shot they list or in the worst case sink from view. In this invention, the shell of the decoy is filled with closed cell plastic or rubber foam in a pressurized state to self-seal the shell by displacement of the shot hole with expanding foam.

### PRIOR ART

Prior art decoys are usually hollow shells which sink when holed. Rigid foam filled decoys generally stay afloat but list because of the large hole left by the blast.

Rigid foam of high density, high tensile, foam are claimed to be unsinkable, but because of the high speed penetration of the lead shot, generally chunks are torn away by the blast resulting in instability and listing and partial sinking. The high density foam typically 900 pounds per square inch tensile strength also imparts a weight penalty to the decoy.

### SUMMARY OF THE INVENTION

The invention relates to waterfowl decoys that are self-sealing in the event they are damaged by errant lead shot. The invention also exhibits some efficient methods of manufacture and detailing advantages.

The present invention solves the prior art problems of sinking or partial sinking of decoys hulls. The present invention has a pressurized foam core that displaces lead shot holes to keep water out and maintain buoyancy and stability to provide a life-like decoy even after lead shot damage.

The versions contained in the present invention exhibit many advantages over prior art. For example, the blow molding of the shell is extremely low cost being typically used for beverage containers like milk, juice and water, but pressure filled with foam provides a low production cost and a durable well proven technology.

The cast foam reinforced coated and mold cured version provides low cost production, a durable decoy with extremely high surface definition and detail to provide high quality marketing potential.

While the present invention had been described with respect to a limited number of embodiments, those skilled in the art will appreciate numerous modifications and variations therefrom. It is intended that the appended claims cover all such modifications and variations as fall within the true spirit and scope of this present invention.

### DETAILED DESCRIPTION OF THE PREFERRED EMBODIMENTS

In the preferred embodiment, FIG. 1 shows a section of a decoy shell 1 filled with foam 2. Foam core 2 is in a pressurized state in the finally cured product. FIG. 2 shows a section of the same decoy with details of lead shot 5 having punctured the decoy 1 from left to right having formed a track 6. The track 6 is shown closed cell foam core 2. In contrast to the prior art shown in FIG. 3 where the shell 1 has been punctured through both walls at 10 allowing ingress of water 9 and the prior art of FIG. 4 showing the penetration by lead shot 5 through the shell 1 and the rigid foam core 3 causing a shattering effect of the rigid foam 8 and providing a large hole for water ingress and subsequent instability of the decoy.

In the preferred embodiment shown in FIGS. 1 and 2 the decoy is typically manufactured in 3 ways to achieve the finish product results. Version 1 has a blow molded skin 1 of typically polypropylene and a foam core 2 of typically Ethylene Vinyl Acetate (EVA) the core 2 being expanded at low temperature or above ambient temperature providing a pressurized foam core at ambient temperature and self-sealing properties as shown in FIG. 2 where the lead shot 5 has formed a track 6 that has closed up from pressure of surrounding pressurized foam 2.

Version 2 is produced by molding a flexible closed cell foam core 2 of typically Ethylene Vinyl Acetate (EVA) the molded and cured core 2 is then dipped, sprayed or otherwise coated in the plastic or rubber. The coating may be fiber powder or otherwise reinforced. The composite decoy is then compressed in a mold and cured to a detailed finish shape providing the shell 1 and the compressed core 2 of FIG. 1 and FIG. 2.

Version 3 has a shell 1 manufactured by conventional method of vacuum forming two halves and molding the halves together but is pressure filled with flexible closed cell foam to form a pressurized core 2.

The pressure produced in core 2 during the process provides compressed gas on the closed cells of the structure and compression and deformation of the cell walls to provide expansion of the foam structure into the holes caused by shot damage to displace water from the decoy to prevent sinking or destabilization of the decoy.

The shell 1 of versions 1 and 3 can also be over filled and flexibly closed cell precast shapes to form the pressurized core 2. The shell 1 of versions 1 and 2 can also be filled with foam or additives that expand or contract with water to provide expansion of the foam when the decoy is penetrated or otherwise damaged.

### BRIEF DESCRIPTION OF DRAWINGS

FIG. 1 shows a cross section of a waterfowl decoy showing the outer shell and the pressurized closed cell foam core.

FIG. 2 shows a cross section of the waterfowl decoy and illustrates the penetration by a lead shot leaving a closed down hole left by the lead shot.

FIG. 3 shows a cross section of a prior art decoy illustrating penetration by a lead shot and the resulting holes allowing water into the hull causing sinking.

FIG. 4 shows a cross section of a prior art decoy that is filled with rigid foam, and the typical result of lead shot shattering the rigid foam.

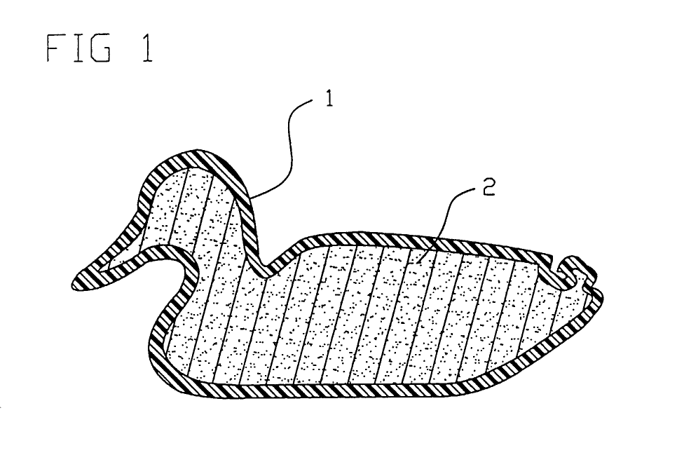

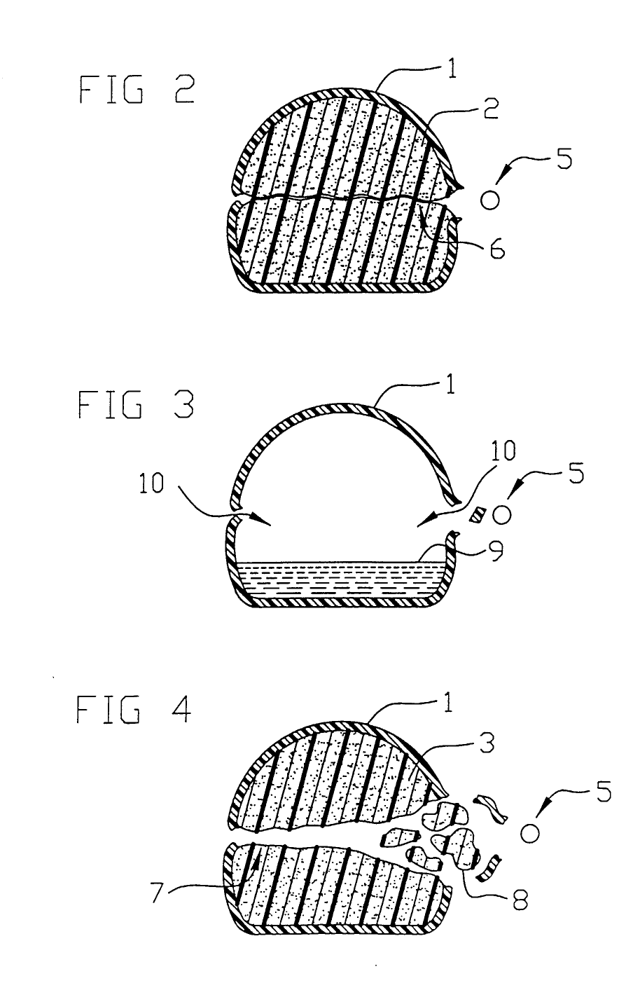

What is claimed is:

1. A waterfowl decoy having a pre-molded shell filled with flexible closed cell foam that is pressurized during manufacture to provide self-sealing properties to the decoy hull in the event that the shell is damaged.

2. A waterfowl decoy having a flexible closed cell foam core coated with a structured material applied and post cured into mold to provide a composite decoy with a detailed surface having a pressurized core to provide self-sealing properties to the decoy hull in the event that the shell is damaged.

3. A decoy in accordance with claim 1 where the shell is blow molded to provide a detailed decoy exterior of the type and size to emulate the waterfowl type required and to fill the shell with a flexible closed cell foam that is pressurized during manufacture to provide the self-sealing properties of claim 1.

4. A decoy in accordance with claim 1 where the shell is vacuumed formed in halves or segments and welded or otherwise joined to form a detailed shell and to fill the shell with a flexible closed cell foam that is pressurized during manufacture to provide the self-sealing properties of claim 1 for the structural materials in claim 2.

5. A decoy according to claim 2 using a cured rubber for the structural material in claim 2.

6. A decoy according to claim 2 using a thermosetting or catalytic compound plastic for the structural material in claim 2.

7. A decoy according to claim 2 using fiber, powder, fabric or other reinforcement medium to strengthen a rubber or plastic coating of claims 5 and 6 to raise the tensile impact and tear resistance of the structural material covering the pressurized core of claim 2.

8. A decoy according to claims 1 using precast or extruded flexible closed cell shapes to form the pressurized core of the decoy by forcing more of the said shapes into the cavity than would otherwise fill the cavity.

9. A decoy according to claims 1, 3, 4 and 8 but using a water activated core or additive to cause expansion of the said core when in contact with water providing pressure or additional pressure to the core to displace water from the decoy.
